(19) United States
(12) Patent Application Publication
(10) Pub. No.: US 2006/0198542 A1
(43) Pub. Date: Sep. 7, 2006

(54) Method for the treatment of compressed sound data for spatialization

(76) Inventors: Abdellatif Benjelloun Touimi, Trebeurden (FR); Marc Emerit, Pabu (FR); Jean-Marie Pernaux, Limoges (FR)

Correspondence Address: Brian J Colandreo;Grossman Tucker Perreault & Pfleger, 55 South Commercial Street, Manchester, NH, 03101, US

(21) Appl. No.: 10/547,311

(22) PCT Filed: Feb. 18, 2004
(86) PCT No.: PCT/FR04/00385

§ 371 Date: Aug. 25, 2005

(30) Foreign Application Priority Data
Feb. 27, 2003 (FR) 03/02 397

(51) Int. Cl. H04R 5/02

(52) U.S. Cl. 381/307

(57) ABSTRACT

The invention relates to the treatment of sound data for spatialized restitution of acoustic signals. At least one first and one second series of weighting terms are obtained for each acoustic signal, said terms representing a direction of perception of said acoustic signal by a listener. The acoustic signals are then applied to at least two sets of filtering units, which are disposed in parallel, in order to provide at least one first and one second output signal (L,R), corresponding to a linear combination of signals provided by said filtering units, which are respectively weighted by the weighting terms of the first and second series. According to the invention, each acoustic signal to be treated is at least partially compression coded and is expressed in the form of a vector of sub-signals associated with respective frequency sub-bands. Matrix filtering applied to each vector is carried out by each filtering unit in the space of the frequential sub-bands.

The invention relates to a processing of sound data for spatialized restitution of acoustic signals.

The appearance of new formats for coding data on telecommunications networks allows the transmission of complex and structured sound scenes comprising multiple sound sources. In general, these sound sources are spatialized, that is to say they are processed in such a way as to afford a realistic final rendition in terms of position of the sources and room effect (reverberation). Such is the case for example for coding according to the MPEG-4 standard which makes it possible to transmit complex sound scenes comprising compressed or uncompressed sounds, and synthesis sounds, with which are associated spatialization parameters (position, effect of the surrounding room). This transmission is made over networks with constraints, and the sound rendition depends on the type of terminal used. On a mobile terminal of PDA type for example (standing for “Personal Digital Assistant”), a listening headset will preferably be used. The constraints of terminals of this type (calculation power, memory size) render the implementation of sound spatialization techniques difficult.

Sound spatialization covers two different processing types. On the basis of a monophone audio signal, one seeks to give a listener the illusion that the sound source or sources are at very precise positions in space (that one desires to be able to modify in real time), and immersed in a space having particular acoustic properties (reverberation, or other acoustic phenomena such as occlusion). By way of example, on telecommunication terminals of mobile type, it is natural to envisage a sound rendition with a stereophonic listening headset. The most effective technique of positioning of the sound sources is then binaural synthesis.

It consists, for each sound source, in filtering the monophone signal via acoustic transfer functions, called HRTFs (standing for “Head Related Transfer Functions”), which model the transformations engendered by the torso, the head and the auricle of the ear of the listener on a signal originating from a sound source. For each position in space, it is possible to measure a pair of these functions (one for the right ear, one for the left ear). The HRTFs are therefore functions of a spatial position, more particularly of an angle of azimuth θ and of an angle of elevation φ, and of the sound frequency f. Thus, for a given subject, a database of acoustic transfer functions of N positions in space is obtained, for each ear, and in which a sound may be “placed” (or “spatialized” according to the terminology used hereinbelow).

It is indicated that a similar spatialization processing consists of a so-called “transaural” synthesis, in which provision is simply made for more than two loudspeakers in a restitution device (which then takes a different form from a headset with two earpieces, left and right).

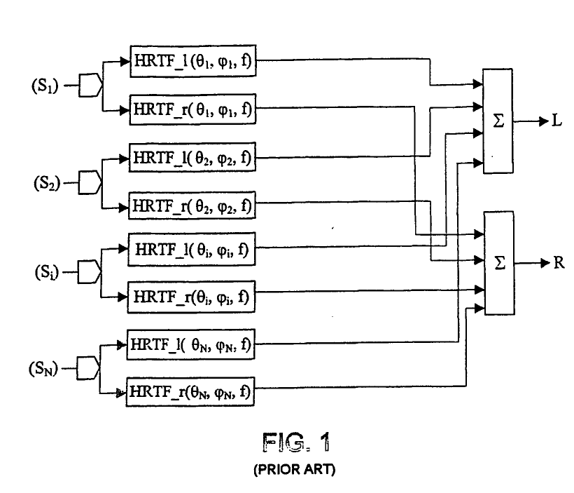

In a conventional manner, the implementation of this technique is effected in a so-called “bichannel” form (processing represented diagrammatically in FIG. 1 pertaining to the prior art). For each sound source to be positioned according to the pair of azimuthal and elevation angles [θ, φ], the signal of the source is filtered with the HRTF function of the left ear and with the HRTF function of the right ear. The two channels, left and right, deliver acoustic signals which are then broadcast to the ears of the listener with a stereophonic listening headset. This bichannel binaural synthesis is of a type referred to hereinbelow as “static”, since in this case the positions of the sound sources do not change over time.

If one wishes, on the contrary, to vary the positions of the sound sources in space in the course of time (“dynamic” synthesis), the filters used to model the HRTFs (left ear and right ear) have to be modified. However, these filters being for the most part of the finite impulse response type (FIR) or infinite impulse response type (IIR), problems of discontinuities of the left and right output signals appear, giving rise to audible “clicks”. The technical solution conventionally employed to alleviate this problem is to make two sets of binaural filters take a turn in parallel. The first set simulates a position [θ1, φ1] at the instant t1, the second a position [θ2, φ2] at the instant t2. The signal giving the illusion of a displacement between the positions at the instants t1 and t2 is then obtained by cross-fading the left and right signals resulting from the filtering processes for the position [θ1, φ1] and for the position [θ2, φ2]. Thus, the complexity of the system for positioning the sound sources is then doubled (two positions at two instants) with respect to the static case.

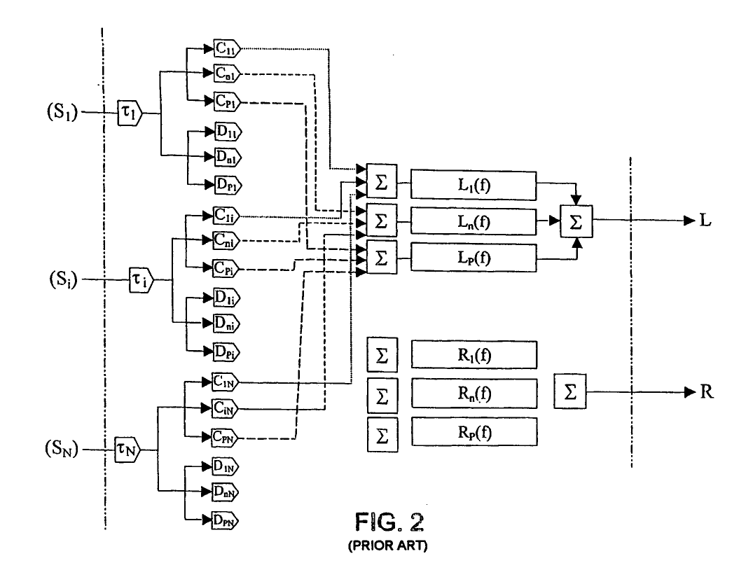

In order to alleviate this problem, techniques of linear decomposition of the HRTFs have been proposed (processing represented diagrammatically in FIG. 2 pertaining to the prior art). One of the advantages of these techniques is that they allow an implementation whose complexity depends much less on the total number of sources to be positioned in space. Specifically, these techniques make it possible to decompose the HRTFs over a basis of functions common to all the positions in space, and therefore depending only on frequency, thereby making it possible to reduce the number of filters required. Thus, this number of filters is fixed, independently of the number of sources and/or of the number of positions of sources to be envisaged. The addition of a further sound source then adds only operations of multiplication by a set of weighting coefficients and by a delay τ₁, these coefficients and this delay depending only on the position [θ, φ]. No further filter is therefore necessary.

These techniques of linear decomposition are also of interest in the case of dynamic binaural synthesis (i.e. when the position of the sound sources varies in the course of time). Specifically, in this configuration, the values of the weighting coefficients and of the delays, rather than the coefficients of the filters, are now made to vary as a function of position alone. The principle described hereinabove of linear decomposition of sound rendition filters generalizes to other approaches, as will be seen hereinbelow.

Moreover, in the various group communication services (teleconferencing, audio conferencing, video conferencing, or the like) or “STREAMING” communication services, to adapt a binary throughput to the bandwidth provided by a network, the audio and/or speech streams are transmitted in a compressed coded format. Hereinbelow we consider only streams initially compressed by coders of frequency type (or by frequency transform) such as those operating according to the MPEG-1 standard (layer I-II-III), the MPEG-2/4 AAC standard, the MPEG-4 TwinVQ standard, the Dolby AC-2 standard, the Dolby AC-3 standard, or else a UIT-T G.722.1 standard for speech coding, or else the Applicant's TDAC coding method. The use of such coders amounts to firstly performing a time/frequency transformation on blocks of the time signal. The parameters obtained are thereafter quantized and coded so as to be transmitted in a frame with other supplementary information required for decoding. This time/frequency transformation may take the form of a bank of frequency subband filters or else a transform of MDCT type (standing for “Modified Discrete Cosine Transform”). Hereinbelow, the same terms “subband domain” will designate a domain defined in a frequency subband space, a domain of a frequency-transformed time space or a frequency domain.

To perform the sound spatialization on such streams, the conventional procedure consists in firstly doing a decoding, carrying out the sound spatialization processing on the time signals, then recoding the signals which result, for transmission to a restitution terminal. This irksome succession of steps is often very expensive in terms of calculation power, of memory required for the processing and of the algorithmic lag introduced. It is therefore often unsuited to the constraints imposed by machines where the processing is performed and to the communication constraints.

The present invention comes to improve the situation.

One of the aims of the present invention is to propose a method of processing sound data grouping together the operations of compression coding/decoding of the audio streams and of spatialization of said streams.

Another aim of the present invention is to propose a method of processing sound data, by spatialization, which adapts to a variable number (dynamically) of sound sources to be positioned.

A general aim of the present invention is to propose a method of processing sound data, by spatialization, allowing wide broadcasting of the spatialized sound data, in particular broadcasting for the general public, the restitution devices being simply equipped with a decoder of the signals received and restitution loudspeakers.

To this end it proposes a method of processing sound data, for spatialized restitution of acoustic signals, in which:
a) at least one first set and one second set of weighting terms, representative of a direction of perception of said acoustic signal by a listener, are obtained for each acoustic signal; and
b) said acoustic signals are applied to at least two sets of filtering units, disposed in parallel, so as to deliver at least a first output signal and a second output signal each corresponding to a linear combination of the acoustic signals weighted by the collection of weighting terms respectively of the first set and of the second set and filtered by said filtering units.

Each acoustic signal in step a) of the method within the sense of the invention is at least partially compression-coded and is expressed in the form of a vector of subsignals associated with respective frequency subbands, and each filtering unit is devised so as to perform a matrix filtering applied to each vector, in the frequency subband space.

Advantageously, each matrix filtering is obtained by conversion, in the frequency subband space, of a (finite or infinite) impulse response filter defined in the time space. Such an impulse response filter is preferably obtained by determination of an acoustic transfer function dependent on a direction of perception of a sound and the frequency of this sound.

According to an advantageous characteristic of the invention, these transfer functions are expressed by a linear combination of frequency dependent terms weighted by direction dependent terms, thereby making it possible, as indicated hereinabove, on the one hand, to process a variable number of acoustic signals in step a) and, on the other hand, to dynamically vary the position of each source over time. Furthermore, such an expression for the transfer functions “integrates” the interaural delay which is conventionally applied to one of the output signals, with respect to the other, before restitution, in binaural processing. To this end, matrices of filters of gains associated with each signal are envisaged.

Thus, said first and second output signals preferably being intended to be decoded into first and second restitution signals, the aforesaid linear combination already takes account of a time shift between these first and second restitution signals, in an advantageous manner.

Finally, between the step of reception/decoding of the signals received by a restitution device and the step of restitution itself, it is possible not to envisage any further step of sound spatialization, this spatialization processing being completely performed upstream and directly on coded signals.

According to one of the advantages afforded by the present invention, association of the techniques of linear decomposition of the HRTFs with the techniques of filtering in the subband domain makes it possible to profit from the advantages of the two techniques so as to arrive at sound spatialization systems with low complexity and reduced memory for multiple coded audio signals.

Specifically, in a conventional “bichannel” architecture, the number of filters to be used is dependent on the number of sources to be positioned. As indicated hereinabove, this problem does not arise in an architecture based on the linear decomposition of HRTFs. This technique is therefore preferable in terms of calculation power, but also memory space required for storing the binaural filters. Finally, this architecture makes it possible to optimally manage the dynamic binaural system, since it makes it possible to effect the “fading” between two instants t1 and t2 on coefficients which depend only on position, and therefore does not require two sets of filters in parallel.

According to another advantage afforded by the present invention, the direct filtering of the signals in the coded domain allows a saving of one complete decoding per audio stream before undertaking the spatialization of the sources, thereby entailing a considerable gain in terms of complexity.

According to another advantage afforded by the present invention, the sound spatialization of the audio stream can occur at various points of a transmission chain (servers, nodes of the network or terminals). The nature of the application and the architecture of the communication used may favor one or other case. Thus, in a teleconferencing context, the spatialization processing is preferably performed at the level of the terminals in a decentralized architecture and, on the contrary, at the audio bridge level (or MCU standing for “Multipoint Control Unit”) in a centralized architecture. For audio “streaming” applications, especially on mobile terminals, the spatialization may be carried out either in the server, or in the terminal, or else during content creation. In these various cases, a decrease in the processing complexity and also the memory required for the storage of the HRTF filters is still felt. For example, for mobile terminals (second and third generation portable telephones, PDA, or pocket micro computers) having heavy constraints in terms of calculational capacity and memory size, provision is preferably made for spatialization processing directly at the level of a contents server.

The present invention may also find applications in the field of the transmission of multiple audio streams included in structured sound scenes, as provided for in the MPEG-4 standard.

Other characteristics, advantages and applications of the invention will become apparent on examining the detailed description hereinbelow, and the appended drawings, in which:

FIG. 1 diagrammatically illustrates a processing corresponding to a static “bichannel” binaural synthesis for temporal digital audio signals Sᵢ, of the prior art;

FIG. 2 diagrammatically represents an implementation of binaural synthesis based on the linear decomposition of HRTFs for uncoded temporal digital audio signals, of the prior art;

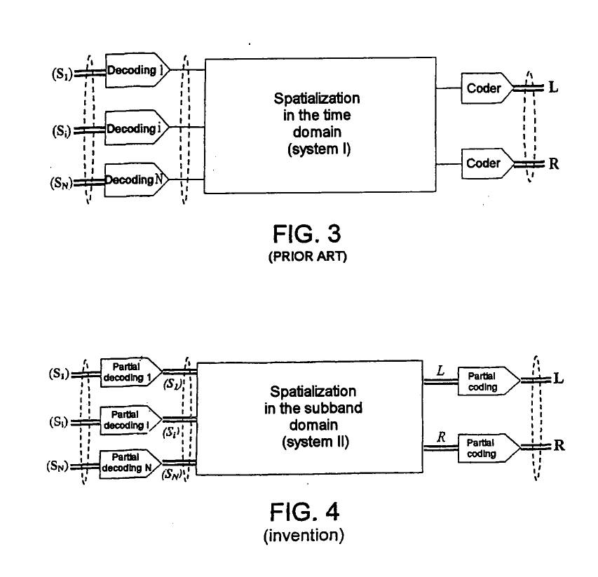

FIG. 3 diagrammatically represents a system, within the sense of the prior art, for binaural spatialization of N audio sources initially coded, then completely decoded for the spatialization processing in the time domain and thereafter recoded for transmission to one or more restitution devices, here from a server;

FIG. 4 diagrammatically represents a system, within the sense of the present invention, for binaural spatialization of N audio sources partially decoded for the spatialization processing in the subband domain and thereafter recoded completely for transmission to one or more restitution devices, here from a server;

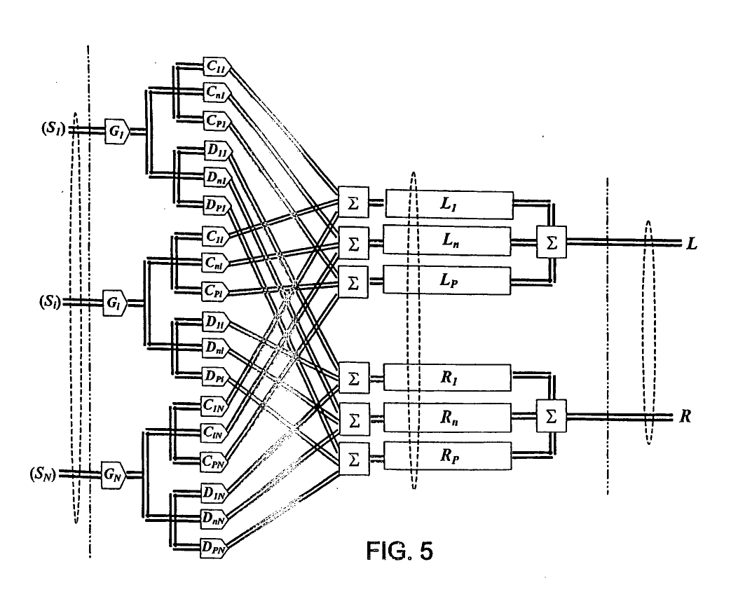

FIG. 5 diagrammatically represents a sound spatialization processing in the subband domain, within the sense of the invention, based on the linear decomposition of the HRTFs in the binaural context;

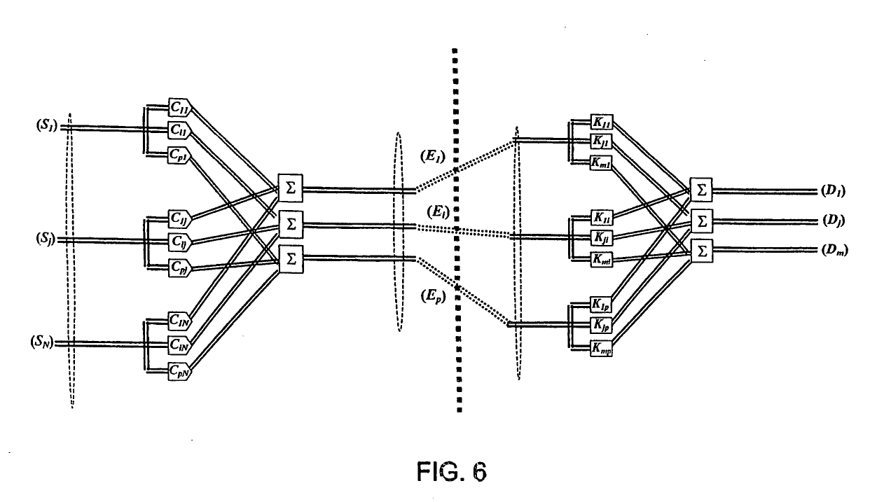

FIG. 6 diagrammatically represents an encoding/decoding processing for spatialization, conducted in the subband domain and based on a linear decomposition of transfer functions in the ambisonic context, in a variant embodiment of the invention;

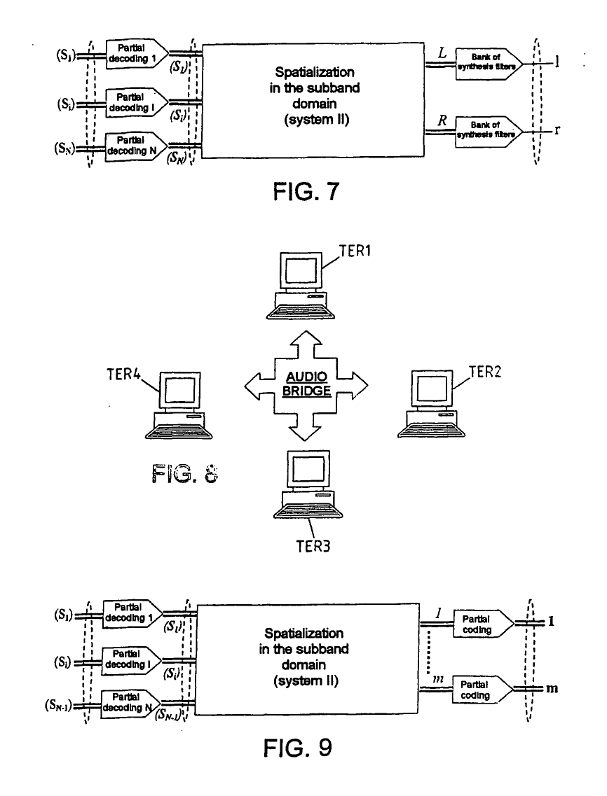

FIG. 7 diagrammatically represents a binaural spatialization processing of N coded audio sources, within the sense of the present invention, which is performed at a communication terminal, according to a variant of the system of FIG. 4;

FIG. 8 diagrammatically represents an architecture of a centralized teleconferencing system, with an audio bridge between a plurality of terminals; and

FIG. 9 diagrammatically represents a processing, within the sense of the present invention, for spatializing (N-1) coded audio sources from among N sources input to an audio bridge of a system according to FIG. 8, performed at this audio bridge, according to a variant of the system of FIG. 4.

Reference is firstly made to FIG. 1 to describe a conventional processing for “bichannel” binaural synthesis. This processing consists in filtering the signal of the sources (Sᵢ) that one wishes to position at a position chosen in space via the left (HRTF_l) and right (HRTF_r) acoustic transfer functions corresponding to the appropriate direction (θi, φi). Two signals are obtained which are then added to the left and right signals resulting from the spatialization of the other sources, so as to give the global signals L and R broadcast to the left and right ears of a listener. The number of filters required is then 2.N for a static binaural synthesis and 4.N for a dynamic binaural synthesis, N being the number of audio streams to be spatialized.

Reference is now made to FIG. 2 to describe a conventional binaural synthesis processing based on the linear decomposition of HRTFs. Here, each HRTF filter is firstly decomposed into a minimum phase filter, characterized by its modulus, and into a pure delay τᵢ. The spatial and frequency dependencies of the moduli of the HRTFs are separated by virtue of a linear decomposition. These moduli of the HRTF transfer functions may then be written as a sum of spatial functions Cₙ(θ,φ) and of reconstruction filters Lₙ(f), as expressed below:
|HRTF(θ,φ,f)|=Σₙ₌₁^{P}Cₙ(θ,φ)Lₙ(f) Eq[1]
Each signal of a source Sᵢ to be spatialized (i=1, . . . , N) is weighted by coefficients Cₙᵢ(θ,φ) (n=1, . . . , P) emanating from the linear decomposition of the HRTFs. These coefficients have the particular feature of depending only on the position [θ,φ] at which one wishes to place the source, and not on the frequency f. The number of these coefficients depends on the number P of basis vectors that were preserved for the reconstruction. The N signals of all the sources, weighted by the “directional” coefficient Cₙᵢ, are then added together (for the right channel and the left channel, separately), then filtered by the filter corresponding to the nth basis vector. Thus, contrary to the “bichannel” binaural synthesis, the addition of a further source does not require the addition of two extra filters (often of FIR or IIR type). The P basis filters are in effect shared by all the sources present. This implementation is said to be “multichannel”. Moreover, in the case of dynamic binaural synthesis, it is possible to vary the coefficients Cₙᵢ(θ,φ) without the appearance of clicks at the output of the device. In this case, only 2.P filters are required, whereas 4.N filters were required by channel synthesis.

In FIG. 2, the coefficients Cₙᵢ correspond to the directional coefficients for source i at the position (θi,φi) and for the reconstruction filter n. They are denoted C for the left path (L) and D for the right path (R). It is indicated that the principle of processing of the right path R is the same as that for the left path L. However, the dotted arrows in respect of the processing of the right path have not been represented for the sake of the clarity of the drawing. Between the two vertical broken lines of FIG. 2, we then define a system denoted I, of the type represented in FIG. 3.

However, before referring to FIG. 3, it is indicated that various procedures have been proposed for determining the spatial functions and the reconstruction filters. A first procedure is based on a so-called Karhunen-Loeve decomposition and is described in particular in document WO94/10816. Another procedure relies on the principal component analysis of the HRTFs and is described in WO96/13962. Document FR-2782228, more recent, also describes such an implementation.

In the case where a spatialization processing of this type is carried out at the communication terminal level, a step of decoding the N signals is required before the spatialization processing proper. This step demands considerable calculational resources (this being problematic on current communication terminals in particular of portable type). Moreover, this step entails a lag in the signals processed, thereby hindering the interactivity of the communication. If the sound scene transmitted comprises a large number of sources (N), the decoding step may in fact become more expensive in terms of calculational resources than the sound specialization step proper. Specifically, as indicated hereinabove, the calculational cost of the “multichannel” binaural synthesis depends only very slightly on the number of sound sources to be spatialized.

The calculational cost of the operation for spatializing the N coded audio streams (in the multichannel synthesis of FIG. 2) can therefore be deduced from the following steps (for the synthesis of one of the two rendition channels, left or right):
decoding (for N signals),
application of the interaural delay τᵢ,
multiplication by the positional gains Cₙᵢ (P×N gains for the collection of N signals),
summation of the N signals for each basis filter of index n,
filtering of the P signals by the basis filters,
and summation of the P output signals from the basis filters.

In the case where the spatialization is not carried out at the level of a terminal but at the level of a server (case of FIG. 3), or else in a node of a communication network (case of an audio bridge in teleconferencing), it is also necessary to add an operation of complete coding of the output signal.

Referring to FIG. 3, the spatialization of N sound sources (forming for example part of a complex sound scene of MPEG4 type) therefore requires:
a complete decoding of the N audio sources S₁, . . . , Sᵢ, . . . , S_{N} coded at the input of the system represented (denoted “system I”) to obtain N decoded audio streams, corresponding for example to PCM signals (standing for “Pulse Code Modulation”),
a spatialization processing in the time domain (“system I”) to obtain two spatialized signals L and R,
and thereafter a complete recoding in the form of left and right channels L and R, conveyed into the communication network so as to be received by one or more restitution devices.

Thus, the decoding of the N coded streams is required before the step of spatializing the sound sources, thereby giving rise to an increase in the calculational cost and the addition of a lag due to the processing of the decoder. It is indicated that the initial audio sources are generally stored directly in coded format, in the current contents servers.

It is indicated furthermore that for restitution on more than two loudspeakers (transaural synthesis or else in an “ambisonic” context that will be described below), the number of signals resulting from the spatialization processing is generally greater than two, thereby further increasing the calculational cost for completely recoding these signals before their transmission by the communication network.

Reference is now made to FIG. 4 to describe an implementation of the method within the sense of the present invention.

It consists in associating the “multichannel” deployment of binaural synthesis (FIG. 2) with the techniques of filtering in the transformed domain (so-called “subband” domain) so as not to have to carry out N complete decoding operations before the spatialization step. One thus reduces the overall calculational cost of the operation. This “integration” of the coding and spatialization operations may be performed in the case of a processing at the level of a communication terminal or of a processing at the level of a server as represented in FIG. 4.

The various steps for processing the data and the architecture of the system are described in detail hereinbelow.

In the case of spatialization of multiple coded audio signals, at the server level as in the example represented in FIG. 4, an operation of partial decoding is then necessary. However, this operation is much less expensive than the decoding operation in a conventional system such as represented in FIG. 3. Here, this operation consists mainly in recovering the parameters of the subbands from the coded, binary audio stream. This operation depends on the initial coder used. It may consist for example of an entropy decoding followed by inverse quantization as in an MPEG-1 layer III coder. Once these parameters of the subbands have been found, the processing is performed in the subband domain, as will be seen hereinbelow.

The overall calculational cost of the operation of spatializing the coded audio streams is then considerably reduced. Specifically, the initial operation of decoding in a conventional system is replaced with an operation of partial decoding of much lesser complexity. The calculational burden in a system within the sense of the invention becomes substantially constant as a function of the number of audio streams that one wishes to spatialize. With respect to conventional systems, one obtains a gain in terms of calculational cost which then becomes proportional to the number of audio streams that one wishes to spatialize. Moreover, the operation of partial decoding gives rise to a lower processing lag than the complete decoding operation, this being especially beneficial in an interactive communication context.

The system for the implementation of the method according to the invention, performing spatialization in the subband domain, is denoted “system II” in FIG. 4.

Described hereinbelow is the obtaining of the parameters in the subband domain from binaural impulse responses.

In a conventional manner, the binaural transfer functions or HRTFs are accessible in the form of temporal impulse responses. These functions generally consist of 256 temporal samples, at a sampling frequency of 44.1 kHz (typical in the field of audio). These impulse reponses may emanate from acoustic simulations or measurements.

The pre-processing steps for obtaining the parameters in the subband domain are preferably the following:
extraction of the interaural delay from binaural impulse responses hₗ(n) and hᵣ(n) (if there are D measured directions in space, we obtain a vector of D values of interaural delay ITD (expressed in seconds));
modelling of the binaural impulse responses in the form of minimum phase filters;
choosing of the number of basis vectors (P) that one wishes to preserve for the linear decomposition of the HRTFs;
linear decomposition of the minimum phase responses according to relation Eq[1] above (we thus obtain the D directional coefficients Cₙᵢ and Dₙᵢ which depend only on the position of the sound source to be spatialized and the P basis vectors which depend only on frequency);
modelling of the basis filters Lₙ and Rₙ in the form of IIR or FIR filters;
calculation of matrices of filters of gains Gᵢ in the subband domain from the D values of ITD (these delays ITD are then considered to be FIR filters intended to be transposed into the subband domain, as will be seen hereinbelow. In the general case, Gᵢ is a matrix of filters. The D directional coefficients Cₙᵢ, Dₙᵢ to be applied in the subband domain are scalars with the same values as the Cₙᵢ and Dₙᵢ respectively in the time domain);
transposition of the basis filters Lₙ and Rₙ, initially in IIR or FIR form, into the subband domain (this operation gives matrices of filters, denoted Lₙ and Rₙ hereinbelow, to be applied in the subband domain. The procedure for performing this transposition is indicated hereinbelow).

It will be noted that the matrices of filters Gi applied independently to each source “integrate” a conventional operation of delay calculation for the addition of the interaural delay between a signal Lᵢ and a signal Rᵢ to be restored. Specifically, in the time domain, provision is conventionally made for delay lines τᵢ (FIG. 2) to be applied to a “left ear” signal with respect to a “right ear” signal. In the subband domain, provision is made rather for such a matrix of filters Gᵢ, which moreover make it possible to adjust gains (for example in terms of energy) of certain sources with respect to others.

In the case of a transmission from a server to restitution terminals, all these steps are performed advantageously off-line. The matrices of filters hereinabove are therefore calculated once and then stored definitively in the memory of the server. It will be noted in particular that the set of weighting coefficients Cₙᵢ, Dₙᵢ advantageously remains unchanged from the time domain to the subband domain.

For spatialization techniques based on filtering by HRTF filters and addition of the ITD delay (standing for “Interaural Time Delay”) such as binaural and transaural synthesis, or else filters of transfer functions in the ambisonic context, a difficulty has arisen finding equivalent filters to be applied to samples in the subband domain. Specifically, these filters emanating from the bank of analysis filters must preferably be constructed in such a way that the left and right time signals restored by the bank of synthesis filters exhibit the same sound rendition, and without any artefact, as that obtained through direct spatialization on a temporal signal. The design of filters making it possible to achieve such a result is not immediate. Specifically, the modification of the spectrum of the signal afforded by filtering in the time domain cannot be carried out directly on the subband signals without taking account of the spectrum overlap phenomenon (“aliasing”) introduced by the bank of analysis filters. The dependency relation between the aliasing components of the various subbands is preferably preserved during the filtering operation so that their removal is ensured by the bank of synthesis filters.

Described hereinbelow is a method for transposing a rational filter S(z), of FIR or IIR type (its z transform being a quotient of two polynomials) in the case of a linear decomposition of HRTFs or of transfer functions of this type, into the subband domain, for a bank of filters with M subbands and with critical sampling, defined respectively by its analysis and synthesis filters Hₖ(z) and Fₖ(z), where 0≦k≦M−1. The expression “critical sampling” is understood to mean the fact that the number of the collection of output samples of the subbands corresponds to the number of samples input. This bank of filters is also assumed to satisfy the perfect reconstruction condition.

We firstly consider a transfer matrix S(z) corresponding to the scalar filter S(z), which is expressed as follows:

$$S ( z ) = [ \begin{matrix}{S}_{0} ( z ) & {S}_{1} ( z ) & ⋯ & & & & {S}_{M - 1} ( z ) \\ {z}^{- 1} {S}_{M - 1} ( z ) & {S}_{0} ( z ) & {S}_{1} ( z ) & ⋯ & & & {S}_{M - 2} ( z ) \\ {z}^{- 1} {S}_{M - 2} ( z ) & {z}^{- 1} {S}_{M - 1} ( z ) & {S}_{0} ( z ) & {S}_{1} ( z ) & ⋯ & & {S}_{M - 3} ( z ) \\ ⋮ & ⋰ & ⋰ & ⋰ & & & ⋮ \\ & & & & & & \\ & & & & & & {S}_{1} ( z ) \\ {z}^{- 1} {S}_{1} ( z ) & ⋯ & & & & {z}^{- 1} {S}_{M - 1} ( z ) & {S}_{0} ( z )\end{matrix} ] ,$$

where Sₖ(z) (0≦k≦M−1) are the polyphase components of the filter S(z).

These components are obtained directly for an FIR filter. For IIR filters, a calculational procedure is indicated in:
[1] A. Benjelloun Touimi, “Traitement du signal audio dans le domaine codé: techniques et applications” [audio signal processing in the coded domain: techniques and applications;] PHD thesis from l'Ecole Nationale Supérieure des Télécommunications de Paris], (Annexe A, p. 141), May 2001.

We thereafter determine polyphase matrices, E(z) and R(z), corresponding respectively to the banks of analysis and synthesis filters. These matrices are determined definitively for the filter bank considered.

We then calculate the matrix for complete subband filtering by the following formula: S_{sb}(z)=z^{k}E(z)S(z)R(z), where z^{k} corresponds to an advance with K=(L/M)−1 (characterizing the filter bank used), L being the length of the analysis and synthesis filters of the filter banks used.

We next construct the matrix \tilde{S}_{sb}(z) whose rows are obtained from those of S_{sb}(Z) as follows: [0 . . . S^{sb}il(z) . . . S^{sb}ii(z) . . . S^{sb}in(z) . . . 0] (0≦n≦M−1), where:
i is the index of the (i+1)th row and lies between 0 and M−1,
l=i−δ mod [M], where δ corresponds to a chosen number of adjacent subdiagonals, the notation mod [M] corresponding to an operation of subtraction modulo M,
n=i+δ mod [M], the notation mod [M] corresponding to an operation of addition modulo M.

It is indicated that the number chosen δ corresponds to the number of bands that overlap sufficiently on one side with the passband of a filter of the bank of filters. It therefore depends on the type of bank of filters used in the coding chosen. By way of example, for the MDCT filter bank, δ may be taken equal to 2 or 3. For the pseudo-QMF filter bank of the MPEG-1 coding, δ is taken equal to 1.

It will be noted that the result of this transposition of a finite or infinite impulse response filter to the subband domain is a matrix of filters of size M×M. However, not all the filters of this matrix are considered during the subband filtering. Advantageously, only the filters of the main diagonal and of a few adjacent subdiagonals may be used to obtain a result similar to that obtained by filtering in the time domain (without however impairing the quality of restitution).

The matrix \tilde{S}_{sb}(z) resulting from this transposition, then reduced, is that used for the subband filtering.

By way of example, indicated hereinbelow are the expressions for the polyphase matrices E(z) and R(z) for an MDCT filter bank, widely used in current transform-based coders such as those operating according to the MPEG-2/4 AAC, or Dolby AC-2 & AC-3, or the Applicant's TDAC standards. The processing below may just as well be adapted to a bank of filters of pseudo-QMF type of the MPEG-1/2 layer I-II coder.

An MDCT filter bank is generally defined by a matrix T=[t_{k,l}], of size M×2M, whose elements are expressed as follows:

$${t}_{k , l} = \sqrt{\frac{2}{M}} h [ l ] cos [ \frac{π}{M} ( k + \frac{1}{2} ) ( l + \frac{M + 1}{2} ) ] ,$$

0≦k≦M−1 and 0≦l≦2M−1, where h[l] corresponds to the weighting window, a possible choice for which is the sinusoidal window which is expressed in the following form:

$$h [ 1 ] = sin [ ( 1 + \frac{1}{2} ) \frac{π}{2 M} ] , 0 \leq 1 \leq 2 M - 1.$$

The polyphase analysis and synthesis matrices are then given respectively by the following formulae:
E(z)=TₗJ_{M}+T₀J_{M}z⁻¹,
R(z)=J_{M}T₀^{T}+J_{M}Tₗ^{T}z⁻¹,
where

$${J}_{M} = ( \begin{matrix}0 & ⋯ & 1 \\ ⋮ & ⋱ & ⋮ \\ 1 & ⋯ & 0\end{matrix} )$$

corresponds to the anti-identity matrix of size M×M and T₀ and T₁ are matrices of size M×M resulting from the following partition:
T=[T₀ T₁].

It is indicated that for this filter bank L=2M and K=1.

For filter banks of pseudo-QMF type of MPEG-1/2 Layer I-II, we define a weighting window h[i], i=0 . . . L-1, and a cosine modulation matrix Ĉ=[cₖₗ], of size M×2M, whose coefficients are given by:

$${c}_{kl} = cos [ \frac{π}{M} ( k + \frac{1}{2} ) ( l - \frac{M}{2} ) ] , 0 \leq 1 \leq 2 M - 1$$

$$and$$

$$0 \leq k \leq M - 1 ,$$

with the following relations: L=2 mM and K=2m−1 where m is an integer. More particularly in the case of the MPEG-1/2 Layer I-II coder, these parameters take the following values: M=32, L=512, m=8 and K=15.

The polyphase analysis matrix is then expressed as follows:

$$E ( z ) = \hat{C} [ \begin{matrix}{g}_{0} ( - {z}^{2} ) \\ {z}^{- 1} {g}_{1} ( - {z}^{2} )\end{matrix} ] ,$$

where g₀(z) and g₁(z) are diagonal matrices defined by:

$$\{ \begin{matrix} {g}_{0} ( z ) = diag [ {G}_{0} ( z ) {G}_{1} ( z ) {⋯G}_{M - 1} ( z ) ] , \\ {g}_{1} ( z ) = diag [ {G}_{M} ( z ) {G}_{M + 1} ( z ) {⋯G}_{2 M - 1} ( z ) ] ,\end{matrix} \\ with \\ {G}_{k} ( - {z}^{2} ) = {\sum }_{l = 0}^{m - 1} {( - 1 )}^{l} h ( 2 lM + k ) {z}^{- 2 l} , 0 \leq k \leq 2 M - 1.$$

In the MPEG-1 Audio Layer I-II standard, the values of the window (−1)¹h(21M+k) are typically provided, with 0≦k≦2M−1, 0≦l≦m−1.

The polyphase synthesis matrix may then be deduced simply through the following formula:
R(z)=z^{-(2m-1)}E^{T}(z⁻¹)

Thus, now referring to FIG. 4 in the sense of the present invention, we proceed to a partial decoding of N audio sources S₁, . . . , Sᵢ, . . . , S_{N} compression-coded, to obtain signals S₁, . . . , Sᵢ, . . . , S_{N} corresponding preferably to signal vectors whose coefficients are values each assigned to a subband. The expression “partial decoding” is understood to mean a process making it possible to obtain on the basis of the compression-coded signals such signal vectors in the subband domain. It is moreover possible to obtain position information from which respective values of gains G₁, . . . , Gᵢ, . . . , G_{N} are deduced (for binaural synthesis) and coefficients Cₙᵢ (for the left ear) and Dₙᵢ (for the right ear) are deduced for the spatialization processing in accordance with equation Eq[1] given hereinabove, as shown in FIG. 5. However, the spatialization processing is conducted directly in the subband domain and the 2P matrices Lₙ and Rₙ of basis filters, obtained as indicated hereinabove, are applied to the signal vectors Sᵢ weighted by the scalar coefficients Cₙᵢ and Dₙᵢ, respectively.

Referring to FIG. 5, the signal vectors L and R, resulting from the spatialization processing in the subband domain (for example in a processing system denoted “System II” in FIG. 4) are then expressed by the following relations, in a representation employing their z transform:

$$L ( z ) = {\sum }_{n = 1}^{P} {L}_{n} ( z ) \cdot [ {\sum }_{i = 1}^{N} {C}_{ni} \cdot {S}_{i} ( z ) ]$$

$$R ( z ) = {\sum }_{n = 1}^{P} {R}_{n} ( z ) \cdot [ {\sum }_{i = 1}^{N} {D}_{ni} \cdot {S}_{i} ( z ) ]$$

In the example represented in FIG. 4, the spatialization processing is performed in a server linked to a communication network. Thus, these signal vectors L and R may be completely compression-recoded to broadcast the compressed signals L and R (left and right channels) in the communication network destined for the restitution terminals.

Thus, an initial step of partial decoding of the coded signals Sᵢ is envisaged, before the spatialization processing. However, this step is much less expensive and faster than the operation of complete decoding which was required in the prior art (FIG. 3). Moreover, the signal vectors L and R are already expressed in the subband domain and the partial recoding of FIG. 4 to obtain the compression-coded signals L and R is faster and less expensive than a complete coding such as represented in FIG. 3.

It is indicated that the two vertical broken lines of FIG. 5 delimit the spatialization processing performed in the “System II” of FIG. 4. In this regard, the present invention is also aimed at such a system comprising means for processing the partially coded signals Sᵢ, for the implementation of the method according to the invention.

It is indicated that the document:
[2] “A Generic Framework for Filtering in Subband Domain” A. Benjelloun Touimi, IEEE 9th workshop on Digital Signal Processing, Hunt, Tex., USA, October 2000,

as well as the document [1] cited above, relate to a general procedure for calculating a transposition into the subband domain of a finite or infinite impulse response filter.

It is indicated moreover that techniques of sound spatialization in the subband domain have been proposed recently, in particular in another document:
[3] “Subband-Domain Filtering of MPEG Audio Signals”, C. A. Lanciani and R. W. Schafer, IEEE Int. Conf. on Acoust., Speech, Signal Proc., 1999.

This latter document presents a procedure making it possible to transpose a finite impulse response filter (FIR) into the subband domain of the pseudo-QMF filter banks of the MPEG-1 Layer I-II and MDCT coder of the MPEG-2/4 AAC coder. The equivalent filtering operation in the subband domain is represented by a matrix of FIR filters. In particular, this proposal fits within the context of a transposition of HRTF filters, directly in their classical form and not in the form of a linear decomposition such as expressed by equation Eq[1] above and over a basis of filters within the sense of the invention. Thus, a drawback of the procedure within the sense of this latter document consists in that the spatialization processing cannot adapt to any number of encoded audio streams or sources to be spatialized.

It is indicated that, for a given position, each HRTF filter (of order 200 for an FIR and of order 12 for an IIR) gives rise to a (square) matrix of filters of dimension equal to the number of subbands of the filter bank used. In document [3] cited above, provision must be made for a sufficient number of HRTFs to represent the various positions in space, this posing a memory size problem if one wishes to spatialize a source at any position whatsoever in space.

On the other hand, an adaptation of a linear decomposition of the HRTFs in the subband domain, in the sense of the present invention, does not present this problem since the number (P) of matrices of basis filters Lₙ and Rₙ is much smaller. These matrices are then stored definitively in a memory (of the content server or of the restitution terminal) and allow simultaneous spatialization processing of any number of sources whatsoever, as represented in FIG. 5.

Described hereinbelow is a generalization of the spatialization processing within the sense of FIG. 5 to other sound rendition processing, such as a so-called “ambisonic encoding” processing. Specifically, a sound rendition system may in a general manner take the form of a sound pick-up system for real or virtual (for a simulation) sound, consisting of an encoding of the sound field. This phase consists in recording p sound signals in a real manner or in simulating such signals (virtual encoding) corresponding to the whole of a sound scene comprising all the sounds, as well as a room effect.

The aforesaid system may also take the form of a sound rendition system consisting in decoding the signals emanating from the sound pick-up so as to adapt them to the sound rendition transducer devices (such as a plurality of loudspeakers or a stereophonic type headset). The p signals are transformed into n signals which feed the n loudspeakers.

By way of example, the binaural synthesis consists in carrying out a pick-up of real sound, with the aid of a pair of microphones introduced into the ears of a human head (artificial or real). Recording may also be simulated by carrying out the convolution of a monophonic sound with the pair of HRTFs corresponding to a desired direction of the virtual sound source. On the basis of one or more monophone signals originating from predetermined sources, are obtained two signals (left ear and right ear) corresponding to a so-called “binaural encoding” phase, these two signals simply being applied thereafter to a headset with two earpieces (such as a stereophonic headset).

However, other encodings and decodings are possible on the basis of the filter decomposition corresponding to transfer functions over a basis of filters. As indicated hereinabove, the spatial and frequency dependencies of the transfer functions, of the HRTF type, are separated by virtue of a linear decomposition and may be written as a sum of spatial functions Cᵢ(θ,φ) and of reconstruction filters Lᵢ(f) which depend on frequency:

$$HRTF ( θ , φ , f ) = {\sum }_{i = 1}^{p} {C}_{i} ( θ , φ ) {L}_{i} ( f )$$

However, it is indicated that this expression may be generalized to any type of encoding, for n sound sources Sⱼ(f) and an encoding format comprising p signals at output, to:

$${E}_{i} ( f ) = {\sum }_{j = 1}^{n} {X}_{ij} ( θ , φ ) \cdot {S}_{j} ( f ) , 1 \leq i \leq p \qquad Eq [ 2 ]$$

where, for example in the case of binaural synthesis, Xᵢⱼ may be expressed in the form of a product of the filters of gains Gⱼ and of the coefficients Cᵢⱼ, Dᵢⱼ.

We refer to FIG. 6 in which N audio streams Sⱼ represented in the subband domain after partial decoding, undergo spatialization processing, for example ambisonic encoding, so as to deliver p signals Eᵢ encoded in the subband domain. Such spatialization processing therefore complies with the general case governed by equation Eq[2] above. It will moreover be noted in FIG. 6 that the application to the signals Sⱼ of the matrix of filters Gⱼ (to define the interaural delay ITD) is no longer required here, in the ambisonic context.

Likewise, a general relation, for a decoding format comprising p signals Eᵢ(f) and a sound rendition format comprising m signals, is given by:

$${D}_{j} ( f ) = {\sum }_{i = 1}^{p} {K}_{ji} ( f ) {E}_{i} ( f ) , 1 \leq j \leq m \qquad Eq [ 3 ]$$

For a given sound rendition system, the filters Kⱼᵢ(f) are fixed and depend, at constant frequency, only on the sound rendition system and its disposition with respect to a listener. This situation is represented in FIG. 6 (to the right of the dotted vertical line), in the example of the ambisonic context. For example, the signals Eᵢ encoded spatially in the subband domain are completely compression-recoded, transmitted in a communication network, recovered in a restitution terminal, partially compression decoded so as to obtain a representation in the subband domain. Finally, after these steps, substantially the same signals Eᵢ described hereinabove are retrieved in the terminal. Processing in the subband domain of the type expressed by equation Eq[3] then makes it possible to recover m signals Dⱼ, spatially decoded and ready to be restored after compression decoding.

Of course, several decoding systems may be arranged in series, according to the application in mind.

For example, in the bidimensional ambisonic context of order 1, an encoding format with three signals W, X, Y for p sound sources is expressed, for the encoding, by:
E₁=W=Σⱼ₌₁ⁿSⱼ
E₂=X=Σⱼ₌₁ⁿ cos(θⱼ)Sⱼ
E₃=Y=Σⱼ₌₁ⁿ sin(θⱼ)Sⱼ

For the “ambisonic” decoding at a restitution device with five loudspeakers on two frequency bands [0, f₁] and [f₁, f₂] with f₁=400 Hz and f₂ corresponding to a passband of the signals considered, the filters Kⱼᵢ(f) take the constant numerical values on these two frequency bands, given in tables I and II below.

TABLE I
values of the coefficients defining the
filters Kⱼᵢ(f) for 0 < f ≦ f₁

| W | X | Y |
|---|---|---|
| 0.342 | 0.233 | 0.000 |
| 0.268 | 0.382 | 0.505 |
| 0.268 | 0.382 | −0.505 |
| 0.561 | −0.499 | 0.457 |
| 0.561 | −0.499 | −0.457 |

TABLE II
values of the coefficients defining the
filters Kⱼᵢ(f) for f₁ < f ≦ f₂

| W | X | Y |
|---|---|---|
| 0.383 | 0.372 | 0.000 |
| 0.440 | 0.234 | 0.541 |
| 0.440 | 0.234 | −0.541 |
| 0.782 | −0.553 | 0.424 |
| 0.782 | −0.553 | −0.424 |

Of course, different methods of spatialization (ambisonic context and binaural and/or transaural synthesis) may be combined at a server and/or at a restitution terminal, such methods of spatialization complying with the general expression for a linear decomposition of transfer functions in the frequency space, as indicated hereinabove.

Described hereinbelow is an implementation of the method within the sense of the invention in an application related to a teleconference between remote terminals.

Referring again to FIG. 4, coded signals (Sᵢ) emanate from N remote terminals. They are spatialized at the teleconferencing server level (for example at the level of an audio bridge for a star architecture such as represented in FIG. 8), for each participant. This step, performed in the subband domain after a phase of partial decoding, is followed by a partial recoding. The signals thus compression coded are thereafter transmitted via the network and, as soon as they are received by a restitution terminal, are completely compression decoded and applied to the two paths left and right l and r, respectively, of the restitution terminal, in the case of a binaural spatialization. At the level of the terminals, the compression decoding processing thus makes it possible to deliver two temporal signals left and right which contain the information regarding the positions of N remote talkers and which feed two respective loudspeakers (headset with two earpieces). Of course, for a general spatialization, for example in the ambisonic context, m paths may be recovered at the output of the communication server, if the spatialization encoding/decoding are performed by the server. However, it is advantageous, as a variant, to envisage the spatialization encoding at the server and the spatialization decoding at the terminal on the basis of the p compression coded signals, on the one hand, so as to limit the number of signals to be conveyed via the network (in general p<m) and, on the other hand, to adapt the spatial decoding to the sound rendition characteristics of each terminal (for example the number of loudspeakers that it comprises, or the like).

This spatialization may be static or dynamic and, furthermore, interactive. Thus, the position of the talkers is fixed or may vary over time. If the spatialization is not interactive, the position of the various talkers is fixed: the listener cannot modify it. On the other hand, if the spatialization is interactive, each listener can configure his terminal so as to position the voice of the other N talkers where he so desires, substantially in real time.

Referring now to FIG. 7, the restitution terminal receives N audio streams (Sᵢ) compression coded (MPEG, AAC, or the like) from a communication network. After partial decoding to obtain the signal vectors (Sᵢ), the terminal (“System II”) processes these signal vectors so as to spatialize the audio sources, here with binaural synthesis, in two signal vectors L and R which are thereafter applied to banks of synthesis filters with a view to compression decoding. The left and right PCM signals, respectively l and r, resulting from this decoding are thereafter intended to feed loudspeakers directly. This type of processing advantageously adapts to a decentralized teleconferencing system (several terminals connected in point-to-point mode).

Described hereinbelow is the case of “streaming” or of downloading of a sound scene, in particular in the context of compression coding according to the MPEG-4 standard.

This scene may be simple, or else complex as often within the framework of MPEG-4 transmissions, where the sound scene is transmitted in a structured format. In the MPEG-4 context, the client terminal receives, from a multimedia server, a multiplexed binary stream corresponding to each of the coded primitive audio objects, as well as instructions as to their composition for reconstructing the sound scene. The expression “audio object” is understood to mean an elementary binary stream obtained via an audio MPEG-4 coder. The MPEG-4 System standard provides a special format, called “AudioBIFS” (standing for “Binary Format for Scene description”), so as to transmit these instructions. The role of this format is to describe the spatio-temporal composition of the audio objects. To construct the sound scene and ensure a certain rendition, these various decoded streams may undergo subsequent processing. Particularly, a sound spatialization processing step may be performed.

In the “AudioBIFS” format, the manipulations to be performed are represented by a graph. The decoded audio signals are provided as input to the graph. Each node of the graph represents a type of processing to be carried out on an audio signal. The various sound signals to be restored or to be associated with other media objects (images or the like) are provided as output from the graph.

The algorithms used are updated dynamically and are transmitted together with the graph of the scene. They are described in the form of routines written in a specific language such as “SAOL” (standing for “Structured Audio Score Language”). This language possesses predefined functions which include in particular and in an especially advantageous manner FIR and IIR filters (which may then correspond to HRTFs, as indicated hereinabove).

Furthermore, in the audio compression tools provided by the MPEG-4 standard, there are transform-based coders used especially for high quality audio transmission (multiphonic and multichannel). Such is the case for the AAC and TwinVQ coders based on the MDCT transform.

Thus, in the MPEG-4 context, the tools making it possible to implement the method within the sense of the invention are already present.

In a receiver MPEG-4 terminal, it is then sufficient to integrate the bottom decoding layer with the nodes of the upper layer which ensures particular processing, such as binaural spatialization by HRTF filters. Thus, after partial decoding of the demultiplexed elementary audio binary streams arising from one and the same type of coder (MPEG-4 AAC for example), the nodes of the “AudioBIFs” graph which involve binaural spatialization may be processed directly in the subband domain (MDCT for example). The operation of synthesis based on filter bank is performed only after this step.

In a centralized multipoint teleconferencing architecture such as represented in FIG. 8, between four terminals in the example represented, the processing of the signals for the spatialization can be performed only at the audio bridge level. Specifically, the terminals TER1, TER2, TER3 and TER4 receive already-mixed streams and therefore no processing can be carried out at their level in respect of spatialization.

It is understood that a reduction in the complexity of processing is especially desired in this case. Specifically, for a conference with N terminals (N≧3), the audio bridge must carry out spatialization of the talkers arising from the terminals for each of the N subsets consisting of (N-1) talkers from among the N participants to the conference. Processing in the coded domain affords more benefit of course.

FIG. 9 diagrammatically represents the processing system envisaged in the audio bridge. This processing is thus performed on a subset of (N-1) coded audio signals from among the N signals input to the bridge. The left and right coded audio frames in the case of binaural spatialization, or the m coded audio frames in the case of general spatialization (for example ambisonic encoding) as represented in FIG. 9, which result from this processing are thus transmitted to the remaining terminal which participates in the teleconference but which does not figure among this subset (corresponding to a “listener terminal”). In total, N processings of the type described above are carried out in the audio bridge (N subsets of (N-1) coded signals). It is indicated that the partial coding of FIG. 9 designates the operation of constructing the coded audio frame after the spatialization processing and to be transmitted on a path (left or right). By way of example, it may involve a quantization of the L and R signal vectors which result from the spatialization processing, being based on an allotted number of bits calculated according to a chosen psychoacoustic criterion. The classical compression-coding processing after the application of the analysis filter bank may therefore be retained and performed together with the spatialization in the subband domain.

Additionally, as indicated hereinabove, the position of the sound source to be spatialized may vary over time, this amounting to making the directional coefficients of the subband domain Cₙᵢ and Dₙᵢ vary over time. The variation of the value of these coefficients is preferably effected in a discrete manner.

Of course, the present invention is not limited to the embodiments described hereinabove by way of examples but extends to other variants defined within the framework of the claims hereinbelow.

1. A method of processing sound data, for spatialized restitution of acoustic signals, in which:
a) at least one first set and one second set of weighting terms, representative of a direction of perception of said acoustic signal by a listener, are obtained for each acoustic signal; and
b) said acoustic signals are applied to at least two sets of filtering units, disposed in parallel, so as to deliver at least a first output signal and a second output signal each corresponding to a linear combination of the acoustic signals weighted by the collection of weighting terms respectively of the first set and of the second set and filtered by said filtering units, wherein:
each acoustic signal in step a) is at least partially compression-coded and is expressed in the form of a vector of subsignals associated with respective frequency subbands, and
each filtering unit is devised so as to perform a matrix filtering applied to each vector, in the frequency subband space.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. The method as claimed in claim 1, wherein it furthermore comprises a step d) consisting in applying a bank of synthesis filters to said first and second output signals, before their restitution.

20. The method as claimed in claim 19, wherein it furthermore comprises a step c) prior to step d) consisting in conveying the first and second signals into a communication network, from a remote server and to a restitution device, in coded and spatialized form, and step b) is performed at said remote server.

21. The method as claimed in claim 19, wherein it furthermore comprises a step c) prior to step d) consisting in conveying the first and second signals into a communication network, from an audio bridge of a multipoint teleconferencing system, of centralized architecture, and to a restitution device of said teleconferencing system, in coded and spatialized form, and step b) is performed at said audio bridge.

22. The method as claimed in claim 19, wherein it furthermore comprises a step subsequent to step a) consisting in conveying said acoustic signals in compression-coded form into a communication network, from a remote server and to a restitution terminal, and steps b) and d) are performed at said restitution terminal.

23. The method as claimed in claim 1, wherein a sound spatialization by binaural synthesis based on a linear decomposition of acoustic transfer functions is applied in step b).

24. The method as claimed in claim 23, wherein a matrix of filters of gains is furthermore applied, in step b), to each partially coded acoustic signal,
said first and second output signals being intended to be decoded into first and second restitution signals,
and wherein the application of said matrix of gain filters amounts to applying a chosen time shift between said first and second restitution signals.

25. The method as claimed in claim 1, wherein, in step a), more than two sets of weighting terms are obtained, and, in step b), more than two sets of filtering units are applied to the acoustic signals so as to deliver more than two output signals comprising encoded ambisonic signals.

26. A processing sound data system, for spatialized restitution of acoustic signals, comprising:
means for obtaining, for each acoustic signal, at least one first set and one second set of weighting terms, representative of a direction of perception of said acoustic signal by a listener; and
at least two sets of filtering units, which said acoustic signals are applied to, said sets of filtering units being disposed in parallel, so as to deliver at least a first output signal and a second output signal each corresponding to a linear combination of the acoustic signals weighted by the collection of weighting terms respectively of the first set Cₙᵢ and of the second set Dₙᵢ and filtered by said filtering units, wherein:
said each acoustic signal is at least partially compression-coded and is expressed in the form of a vector of subsignals associated with respective frequency subbands, and
each filtering unit is devised so as to perform a matrix filtering applied to each vector, in the frequency subband space.

27. The system as claimed in claim 26, wherein each matrix filtering is obtained by conversion, in the frequency subband space, of a filter represented by an impulse response in the time space.

28. The system as claimed in claim 27, wherein each impulse response filter is obtained by determination of an acoustic transfer function dependent on a direction of perception of a sound and the frequency of this sound.

29. The system as claimed in claim 28, wherein said transfer functions are expressed by a linear combination of frequency dependent terms weighted by direction dependent terms.

30. The system as claimed in claim 26, wherein said weighting terms of the first and of the second set depend on the direction of the sound.

31. The system as claimed in claim 30, wherein the direction is defined by an azimuth angle and an angle of elevation.

32. The system as claimed in claim 27, wherein the matrix filtering is expressed on the basis of a matrix product involving polyphase matrices corresponding to banks of analysis and synthesis filters and a transfer matrix whose elements are dependent on the impulse response filter.

33. The system as claimed in claim 26, wherein the matrix of the matrix filtering is of reduced form and comprises a diagonal and a predetermined number of adjacent subdiagonals below and above, whose elements are not all zero.

34. The system as claimed in claims 32, wherein the rows of the matrix of the matrix filtering are expressed by:
(0 . . . S^{sb}il(z) . . . S^{sb}ii(z) . . . S^{sb}in(z) . . . 0), where:
i is the index of the (i+1)th row and lies between 0 and M−1, M corresponding to a total number of subbands,
l=i−δ mod(M), where δ corresponds to said number of adjacent subdiagonals, the notation mod(M) corresponding to an operation of subtraction modulo M,
n=i+δ mod(M), the notation mod(M) corresponding to an operation of addition modulo M,
and S^{sb}ij(z) are the coefficients of said product matrix involving the polyphase matrices of the banks of analysis and synthesis filters and said transfer matrix.

35. The system as claimed in claim 32, wherein said product matrix is expressed by:
S^{sb}(z)=z^{k}E(z)S(z)R(z), where:
Z^{K} is an advance defined by the term K=(L/M)−1 where L is the length of the impulse response of the analysis and synthesis filters of the banks of filters and M the total number of subbands,
E(z) is the polyphase matrix corresponding to the bank of analysis filters,
R(z) is the polyphase matrix corresponding to the bank of synthesis filters, and
S(z) corresponds to said transfer matrix.

36. The system as claimed in claim 32, wherein said transfer matrix is expressed by:
$$S ( z ) = [ \begin{matrix}{S}_{0} ( z ) & {S}_{1} ( z ) & ⋯ & & & {S}_{M - 1} ( z ) \\ {z}^{- 1} {S}_{M - 1} ( z ) & {S}_{0} ( z ) & {S}_{1} ( z ) & ⋯ & & {S}_{M - 2} ( z ) \\ {z}^{- 1} {S}_{M - 2} ( z ) & {z}^{- 1} {S}_{M - 1} ( z ) & {S}_{0} ( z ) & {S}_{1} ( z ) & ⋯ & {S}_{M - 3} ( z ) \\ ⋮ & ⋰ & ⋰ & ⋰ & & ⋮ \\ & & & & & {S}_{1} ( z ) \\ {z}^{- 1} {S}_{1} ( z ) & ⋯ & & & {z}^{- 1} {S}_{M - 1} ( z ) & {S}_{0} ( z )\end{matrix} ] ,$$
where Sₖ(z) are the polyphase components of the impulse response filter S(z), with k lying between 0 and M−1 and M corresponding to a total number of subbands.

37. The system as claimed in claim 32, wherein said banks of filters operate by critical sampling.

38. The system as claimed in claim 32, wherein said banks of filters satisfy a perfect reconstruction property.

39. The system as claimed in claim 27, wherein the impulse response filter is a rational filter, expressed in the form of a fraction of two polynomials.

40. The system as claimed in claim 39, wherein said impulse response filter is an infinite impulse response filter.

41. The system as claimed in claim 33, wherein said predetermined number of adjacent subdiagonals is dependent on a type of filter bank used in the compression coding chosen.

42. The system as claimed in claim 41, wherein said predetermined number is between 1 and 5.

43. The system as claimed in claim 32, comprising a memory for storing the matrix elements resulting from said matrix product, said matrix elements being intended to be reused for all partially coded acoustic signals to be spatialized.
